(19) United States
(12) Patent Application Publication
(10) Pub. No.: US 2026/0161453 A1
(43) Pub. Date: Jun. 11, 2026

(54) INFORMATION PROCESSING DEVICE AND INFORMATION PROCESSING SYSTEM

(71) Applicant: TOYOTA JIDOSHA KABUSHIKI KAISHA, Toyota-shi (JP)

(72) Inventors: Kiminobu Makino, Tokyo (JP); Mitsuhiro Ono, Yokosuka-shi (JP); Junya Oikawa, Kawasaki-shi (JP); Hiroki Kano, Yokohama-shi (JP); Takuya Yoshida, Tokyo (JP); Naoto Matsumoto, Tokyo (JP)

(73) Assignee: TOYOTA JIDOSHA KABUSHIKI KAISHA, Toyota-shi (JP)

(21) Appl. No.: 19/333,704

(22) Filed: Sep. 19, 2025

(30) Foreign Application Priority Data
Dec. 11, 2024 (JP) 2024-216922

(51) Int. Cl. G06F 9/48

(52) U.S. Cl. CPC G06F 9/4893

(57) ABSTRACT

An information processing device that is installed in a vehicle acquires power status data that is data indicating a level of surplus power of an edge server, equipped with a power generation facility that uses renewable energy, and commissions the edge server to execute at least part of a plurality of calculation tasks generated in the vehicle, based on the power status data.

### CROSS-REFERENCE TO RELATED APPLICATION

This application claims priority to Japanese Patent Application No. 2024-216922 filed on Dec. 11, 2024. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

There is a technology for providing information to vehicles by using edge servers associated with geographically dispersed regions (e.g., Japanese Unexamined Patent Application Publication No. 2022-032310 (JP 2022-032310 A)).

### SUMMARY

An object of the present disclosure is to allocate tasks depending on power status.

One aspect of the present disclosure is
an information processing device that is installed in a vehicle and includes a control unit that executes acquiring power status data that is data indicating a level of surplus power of an edge server, equipped with a power generation facility that uses renewable energy, and commissioning the edge server to execute at least part of a plurality of calculation tasks generated in the vehicle, based on the power status data.

One aspect of the present disclosure is
an information processing system including one or more edge servers equipped with a power generation facility that uses renewable energy, and an information processing device that is installed in a vehicle, in which each of the one or more edge servers transmits power status data that is data indicating a level of surplus power to the information processing device, and when the power status data that is received from the one or more edge servers indicates that there is an edge server with surplus power, the information processing device commissions a corresponding edge server to execute at least part of a plurality of calculation tasks.

Examples of other aspects include a method that is executed by the above device or system, a program that causes a computer to execute the method, and a computer-readable storage medium that stores the program in a non-transitory manner.

According to the present disclosure, tasks can be allocated depending on power status.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a communication system according to an embodiment;

FIG. 2 is a configuration diagram of an in-vehicle device according to the embodiment;

FIG. 3 is a configuration diagram of an edge server and a central server according to the embodiment;

FIG. 4 is a diagram for describing a flow of processing executed by each device;

FIG. 5A is an example of power status data and determination data that are used by the in-vehicle device;

FIG. 5B is an example of power status data and determination data that are used by the in-vehicle device; and

FIG. 6 is a flowchart of processing that is executed by the in-vehicle device.

### DETAILED DESCRIPTION OF EMBODIMENTS

There is a system in which data (sensor data) that is collected by various types of sensors that are installed in vehicles is aggregated in a central server for processing. This enables maps of roads that are travelable by the vehicles to be automatically generated or updated, for example.
However, aggregating and processing all sensor data in a central server causes problems such as placing a load on calculation resources and on communication bandwidth of the central server, resulting in reduced efficiency and reliability of the entire system.

For this reason, a system has been conceived in which an edge server is placed in each of a number of areas in which the vehicles travel, and the edge servers perform pre-processing of data. For example, an edge server collects data from vehicles passing through a predetermined area, performs primary processing, and transmits results thereof to the central server. For example, primary processing such as data aggregation, filtering, removal of outliers, and data compression can be performed at the edge server, and the results can be sent to the central server at a predetermined timing, thereby reducing the load on the central server.

Furthermore, in recent years, there have been attempts to install power generation facilities that use renewable energy such as solar power or the like alongside edge servers, and operate the edge servers using power that is produced by the power generation facilities.

In such configurations, the calculation resources that the edge server can provide may increase beyond design value, depending on the amount of power generation. For example, in fine weather, the amount of power that can be consumed by the edge server increases as the amount of power generated increases. Allocating this power among processors and so forth enables the calculation power of the edge server to be increased beyond the design value.
In such a situation, in addition to the data processing services that the edge server is intended to provide, services can also be provided such as receiving tasks from external devices (e.g., vehicles traveling nearby) and executing the tasks on behalf of the external devices.

However, the amount of power that is generated by renewable energy is not constant, and accordingly the amount of calculation resources that can be provided to external devices can vary depending on the power generation status. This means that tasks may or may not be able to be accepted from external devices, depending on the weather. Furthermore, from the perspective of the external devices, whether the edge server can be commissioned to execute tasks varies depending on the weather, meaning that task execution plans cannot be appropriately decided.
The information processing device according to the present disclosure solves such problems.

An information processing device according to one aspect of the present disclosure is an information processing device that is installed in a vehicle and includes a control unit that executes acquiring power status data that is data indicating a level of surplus power of an edge server, equipped with a power generation facility that uses renewable energy, and commissioning the edge server to execute at least part of a plurality of calculation tasks generated in the vehicle, based on the power status data.

A calculation task is a task that is generated within a vehicle, and typical examples include image recognition processing for autonomous driving, abnormality detection processing based on sensor data, data encryption processing, and so forth.
The control unit acquires power status data regarding a predetermined edge server that is equipped with a power generation facility that uses renewable energy.

The power status data is data that indicates the level of surplus power in the edge server. Power generation facilities that use renewable energy fluctuate with regard to the amount of power they can supply, and accordingly surplus power is generated depending on the load on the edge servers. The power status data is data for performing notification regarding this level of surplus power. The power status data may include, for example, data indicating the power currently suppliable by a power generating facility, data indicating the current power consumption by an edge server, or both. The control unit can determine whether surplus power is being generated in the edge server based on the power status data.

The control unit commissions the edge server to execute at least part of the calculation tasks that are generated in itself, based on the power status data. For example, when the control unit determines, based on the power status data, that surplus power is being generated in an object edge server, the control unit can commission the corresponding edge server to execute a calculation task that has been generated within the vehicle, in order to perform processing of the calculation task using the surplus power.
According to this configuration, surplus power can be efficiently utilized in the edge server.

The power status data may include any data, as long as the amount of surplus power in the edge server can be estimated.

The control unit may also commission the edge server to execute more calculation tasks or calculation tasks with a larger computation amount, the more surplus power the edge server has.
This is because it is thought that the more surplus power there is, the more calculation resources the edge server can provide.

Specific embodiments of the present disclosure will be described below with reference to the drawings. The hardware configuration, module configuration, functional configuration, and so forth, described in each embodiment are not intended to limit the technical scope of the disclosure to these configurations alone, unless otherwise specified.

### First Embodiment

### System Overview

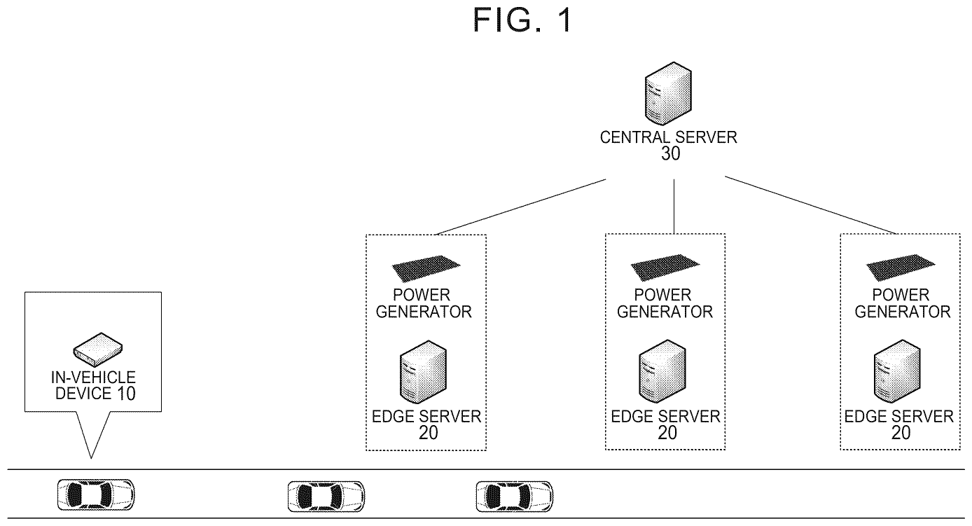

An overview of a communication system according to a first embodiment will be described with reference to FIG. 1. The communication system according to the present embodiment includes an in-vehicle device 10 that is installed in a vehicle, a plurality of edge servers 20 installed at roadside sites, and a central server 30.

A vehicle 1 is a connected vehicle that is capable of wireless communication with the edge servers 20. The vehicle 1 is equipped with the in-vehicle device 10. The in-vehicle device 10 has a function of collecting sensor data while the vehicle 1 is traveling, and transmitting the collected sensor data to the edge servers 20.

The edge servers 20 are server devices that are capable of communicating, via wireless communication, with the vehicle 1 (the in-vehicle device 10) traveling within a predetermined communication area. The edge servers 20 are configured to be able to perform wireless communication with the vehicle 1 within predetermined communication areas that are centered around themselves. Also, the edge servers 20 have functions of subjecting the sensor data that is collected from the vehicles 1 to primary processing, and transmitting the results thereof to the central server 30.

The central server 30 is a server device that performs predetermined data processing based on the sensor data that is collected from a plurality of the vehicles 1. For example, the central server 30 can generate three-dimensional road map data based on image data (images taken by in-vehicle cameras), and so forth, collected from multiple vehicles 1.

The edge servers 20 are disposed between the central server 30 and the vehicles 1, and executes processing of collecting sensor data from the vehicles 1. Also, the edge servers 20 execute primary processing of the sensor data that is collected, and transmit the results thereof to the central server 30. Primary processing may be, for example, a process that converts sensor data into an intermediate product. For example, when the central server 30 is going to execute processing of generating a three-dimensional road map based on sensor data, the edge servers 20 may execute processing and so forth of estimating three-dimensional shapes of buildings based on sensor data such as image data and so forth.
Due to the edge servers 20 performing information processing at locations geographically close to the vehicles 1, load on the central server 30 and the amount of data flowing over the network can be reduced.

In the present embodiment, the edge servers 20 have power generators that operate under renewable energy, and can operate using power that is generated by renewable energy (typically, solar power). The edge servers 20 can operate by securing a minimum amount of power from a commercial power source, while also using power that is supplied from the power generators. That is to say, when the amount of power generated by the power generators increases, the amount of power that is usable by the edge servers 20 increases, and accordingly the calculation resources that are usable by the edge servers 20 also increase.
In the present embodiment, when the calculation resources increase to or above a predetermined value (when calculation resources are generated that exceed the amount by which the original service can be provided), the edge servers 20 use the calculation resources, of which the amount has increased, to provide services of executing commissioned calculation tasks for external devices (e.g., in-vehicle devices 10).

In the present embodiment, each of the edge servers 20 transmits data regarding the power status of itself to the vehicles 1 traveling within a predetermined communication area. The data may include data indicating the power that can be supplied by the power generators, and data indicating the power consumption of the edge servers themselves. The in-vehicle devices 10 that are installed in the vehicles 1 determine, based on the data, whether surplus power is being generated at object edge servers 20. When surplus power is generated in the object edge servers 20, the in-vehicle devices 10 commission the edge servers 20 to execute at least part of calculation tasks generated in the own vehicles. This enables surplus power that is generated at the edge servers 20 to be efficiently utilized.

In the present embodiment, the edge servers 20 perform data processing for generating a three-dimensional road map, i.e., periodically collecting sensor data from the vehicles 1, executing primary processing, and then executing processing of transmitting the data to the central server 30. This processing can be said to be the original role to be executed by the edge server 20. Also, during a period when surplus power is being generated, the edge servers 20 process tasks that are transmitted from the vehicles 1 in response to commissions from the vehicles 1. The tasks that are transmitted from vehicles 1 can be, for example, calculation tasks for analyzing data necessary for the vehicles 1 to perform automated driving.

### System Configuration

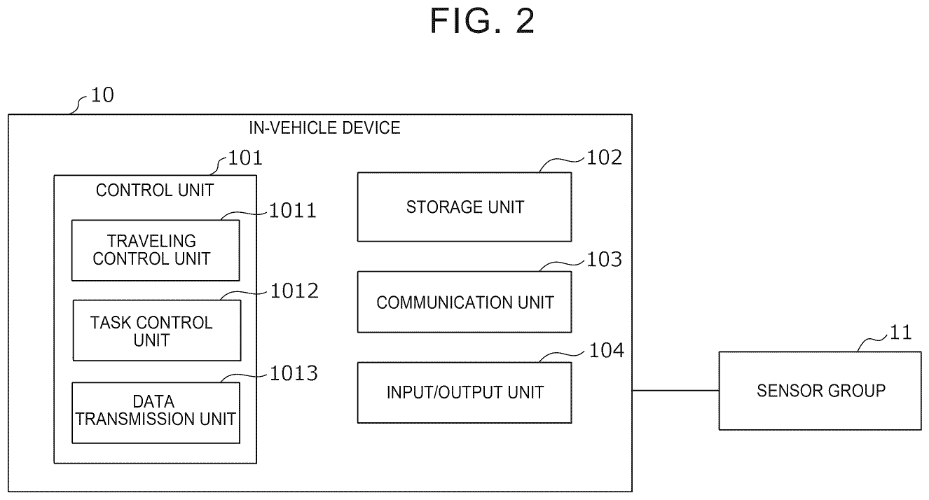

Next, the hardware configuration and software configuration of the devices making up the system will be described.
FIG. 2 is a diagram schematically illustrating an example of a configuration of the in-vehicle device 10 that can be installed in the vehicle 1.

The in-vehicle device 10 can be configured as a computer that includes a processor (a central processing unit (CPU), a graphics processing unit (GPU), or the like), a main storage device (random-access memory (RAM), read only memory (ROM), or the like), and an auxiliary storage device (erasable programmable read only memory (EPROM), a hard disk drive, a removable medium, or the like). An operating system (OS), various types of programs, various types of tables, and so forth, are stored in the auxiliary storage device, and the programs that are stored therein are executed, whereby various functions (software modules) can be realized to meet predetermined purposes, which will be described later. Note, however, that part or all of the functions may be realized as hardware modules by a hardware circuit such as an application specific integrated circuit (ASIC) or a field programmable gate array (FPGA), for example.

The in-vehicle device 10 is configured including a control unit 101, a storage unit 102, a communication unit 103, and an input/output unit 104.

The control unit 101 is a computing unit that realizes various functions of the in-vehicle device 10 by executing predetermined programs. The control unit 101 can be realized by a hardware processor such as a CPU, for example. Also, the control unit 101 may be configured including RAM, ROM, cache memory, or the like.

In the present embodiment, the control unit 101, which the in-vehicle device 10 has, is configured including, as software modules, a traveling control unit 1011, a task control unit 1012, and a data transmission unit 1013. These software modules may be realized by the control unit 101 (CPU or the like) executing programs stored in the storage unit 102.

The traveling control unit 1011 controls traveling of the vehicle 1 that is autonomous. The traveling control unit 1011 extracts information necessary for autonomous driving by analyzing sensor data acquired from a sensor group 11 that will be described later, and controls the traveling of the vehicle 1 based on the information.

Specifically, the traveling control unit 1011 executes tasks like analyzing sensor data to recognize objects such as other vehicles, traffic signs, lane marking lines, and traffic signal lights, and tasks of deciding the traveling path and the acceleration/deceleration of the vehicle, and so forth, based on the analysis results. The sensor data can be analyzed, for example, using a machine learning model. The machine learning model may be divided into multiple parts, such as for example, one corresponding to a function for detecting obstructions, one corresponding to a function for detecting traffic signal lights, one corresponding to a function for detecting lanes, and so on.
A deep neural network (DNN) or the like, for example, can be used as a machine learning model. The number of layers of the DNN may be set optionally depending on the object of analysis. For example, a shallow neural network may be used to analyze simple features, such as in a case of detecting lane marking lines, or the like, whereas a deep neural network may be used in a case of analyzing higher level concepts, such as determining objects or the like.
These tasks may be executed in the control unit 101 or may be executed in an edge server 20 (described later).
The task control unit 1012 decides whether to execute the task that is generated by the traveling control unit 1011 itself, or to commission the edge server 20 to execute the task.
Specifically, the task control unit 1012 receives, from an edge server 20 with which communication can be performed, data regarding power status (hereinafter, power status data) of this edge server 20, and based on the power status data and the power status of the own vehicle, decides whether the task that is generated by the traveling control unit 1011 will be executed in the device itself or in the edge server 20.
For example, when the own vehicle itself has no surplus power and the edge server 20 has surplus power, the task control unit 1012 can decide to commission the edge server 20 to execute the object task. In this case, the task control unit 1012 transmits the task to the edge server 20 and receives results from the edge server 20.
Also, when the own vehicle has surplus power or the edge server 20 has no surplus power, the task control unit 1012 can decide not to commission the edge server 20 to execute the object task. In this case, the task control unit 1012 causes the task to be executed by the device itself (in the control unit 101).

The data transmission unit 1013 periodically collects and transmits data necessary for the central server 30 to generate a three-dimensional road map. For example, the data transmission unit 1013 periodically executes processing of transmitting images that are acquired by an in-vehicle camera that is included in the sensor group 11, and data that is obtained by analyzing the images, to an edge server 20 that is located in the vicinity of the own vehicle.
The data that is generated and transmitted by the data transmission unit 1013 has no direct relationship to the sensor data that is used by the traveling control unit 1011.

The storage unit 102 is means for storing information, and is made up of storage medium such as RAM, a magnetic disk, flash memory, or the like. The storage unit 102 stores programs to be executed by the control unit 101, data to be used by these programs, and so forth.

The communication unit 103 is a wireless communication interface for transmitting and receiving wireless signals to and from the edge server 20. The communication unit 103 is configured to be able to transmit and receive wireless signals conforming to standards such as, for example, wireless LAN, Dedicated Short Range Communications (DSRC), and so forth. The communication range of wireless signals can be, for example, in the order of a few hundred meters to a few kilometers.

The input/output unit 104 is a unit that receives input from a vehicle occupant and presents information to the occupant. Specifically, the input/output unit 104 is made up of a touch panel and control means thereof, and a liquid crystal display and control means thereof. The touch panel and the liquid crystal display are made up of one touchscreen display in the present embodiment.

The in-vehicle device 10 is also connected to a set of a plurality of the sensors (sensor group 11) for acquiring sensor data that is used while the vehicle 1 is traveling.
The sensors that are included in the sensor group 11 may be sensors that acquire physical quantities, or sensors that acquire image data or the like. For example, examples of sensors that are included in the sensor group include a sensor that detects vehicle speed, an image sensor that acquires visible light images and distance images of forward of the vehicle, a sensor that acquires position information, a radar sensor, a Light Detection and Ranging (LiDAR) device, and the like.

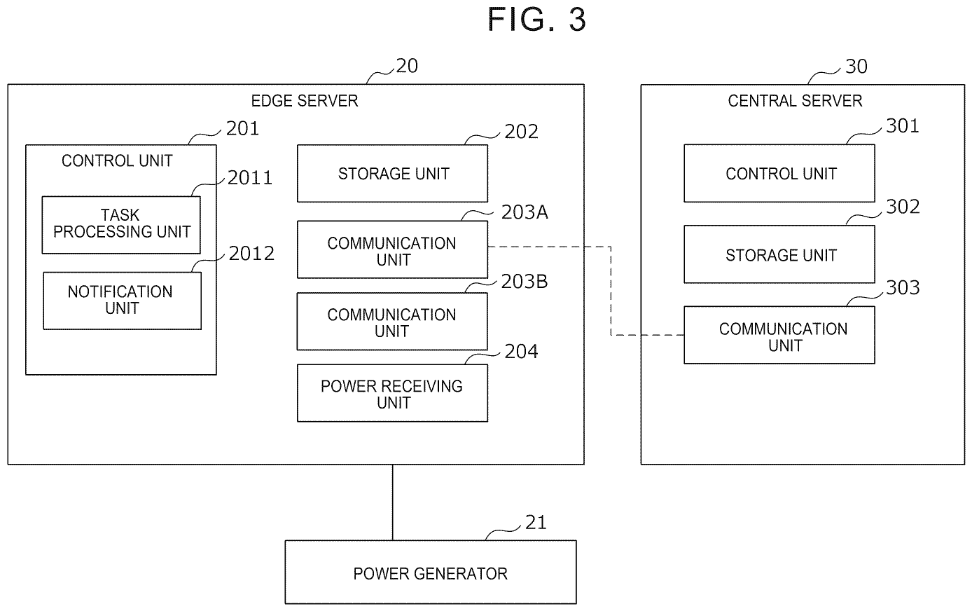

Next, a configuration of the edge server 20 will be described. FIG. 3 is a diagram schematically illustrating an example of a configuration of the edge server 20 and the central server 30.

In the same way as with the in-vehicle device 10, the edge server 20 can be configured as a computer having a processor (CPU, GPU, or the like), a main memory device (RAM, ROM, or the like), and an auxiliary storage device (EPROM, hard disk drive, removable media, or the like).

The edge server 20 is configured including a control unit 201, a storage unit 202, a communication unit 203A (203B) , and a power receiving unit 204.

The control unit 201 is a computing unit that realizes various functions of the edge server 20 by executing predetermined programs. The control unit 201 can be realized by a hardware processor such as a CPU or the like, for example. Also, the control unit 201 may be configured including RAM, ROM, cache memory, or the like.

In the present embodiment, the control unit 201, which the edge server 20 has, is configured including a task processing unit 2011 and a notification unit 2012 as software modules. These software modules may be realized by the control unit 201 (CPU or the like) executing programs that are stored in the storage unit 202.

The task processing unit 2011 executes predetermined tasks depending on the role of the edge server 20. In the present embodiment, the task processing unit 2011 executes the following two types of tasks.
(1) Task of performing data processing for generating a three-dimensional road map
   This is a task of performing primary processing on the sensor data that is collected from the vehicle 1, and transmitting the processing results to the central server 30. This task is executed in response to periodic transmission of sensor data from the vehicle 1. The transmission of the processing results to the central server 30 may be executed at predetermined intervals.
(2) Task commissioned by the vehicle 1 (in-vehicle device 10) to be executed
   As described above, when the edge server 20 has surplus power, the in-vehicle device 10 commissions the edge server 20 to execute a task. In response to this, the edge server 20 (task processing unit 2011) executes the task that is transmitted from the in-vehicle device 10.

The notification unit 2012 generates data relating to the power status of itself (power status data), and transmits the data to the vehicle 1 (in-vehicle device 10) that is located within the communication area of itself. The power status data is, for example, data notifying the real-time power being consumed by the device itself (edge server 20) and the real-time power that can be supplied by a power generator 21 that will be described later.

The storage unit 202 is means for storing information, and is made up of a storage medium such as RAM, a magnetic disk, flash memory, or the like. The storage unit 202 stores programs to be executed by the control unit 201, data to be used by these programs, and so forth.

The communication unit 203A is a communication interface for transmitting and receiving data to and from the central server 30. The communication unit 203A is, for example, a communication interface conforming to standards such as Ethernet (registered trademark) or the like.
The communication unit 203B is a wireless communication interface for transmitting and receiving wireless signals to and from the in-vehicle device 10. The communication unit 203B is configured to be able to transmit and receive wireless signals conforming to standards such as, for example, wireless LAN, DSRC, and so forth.

The power receiving unit 204 is an interface that receives power that is generated by the power generator 21. The power receiving unit 204 is configured including, for example, a converter that converts output from a solar panel into a constant voltage, an inverter that converts direct current into alternating current, and so forth. Also, the power receiving unit 204 can acquire the power that is generated by the power generator 21 in real time (power that can be supplied to itself).
The power generator 21 is a device that generates power using renewable energy, and is typically an array of solar panels.

Next, a configuration of the central server 30 will be described.

Like the edge server 20, the central server 30 can be configured as a computer having a processor (CPU, GPU, etc.), a main memory device (RAM, ROM, etc.), and an auxiliary storage device (EPROM, hard disk drive, removable media, etc.).

The central server 30 is configured including a control unit 301, a storage unit 302, and a communication unit 303.

The control unit 301 is a computing unit that realizes various types of functions of the central server 30 by executing predetermined programs. The control unit 301 can be realized by a hardware processor such as a CPU or the like, for example. Also, the control unit 301 may be configured including RAM, ROM, cache memory, or the like.

In the present embodiment, the control unit 301, which the central server 30 has, executes processing of generating a three-dimensional road map, based on the information that is collected from the edge server 20.

The storage unit 302 is means for storing information, and is made up of a storage medium such as RAM, a magnetic disk, flash memory, or the like. The storage unit 302 stores programs to be executed by the control unit 301, data to be used by these programs, and so forth.

The communication unit 303 is a communication interface for communicating with the edge server 20. This communication interface may be a wired interface or a wireless interface.

### Overview of Processing

Next, a flow of processing that is performed by the edge server 20 and the in-vehicle

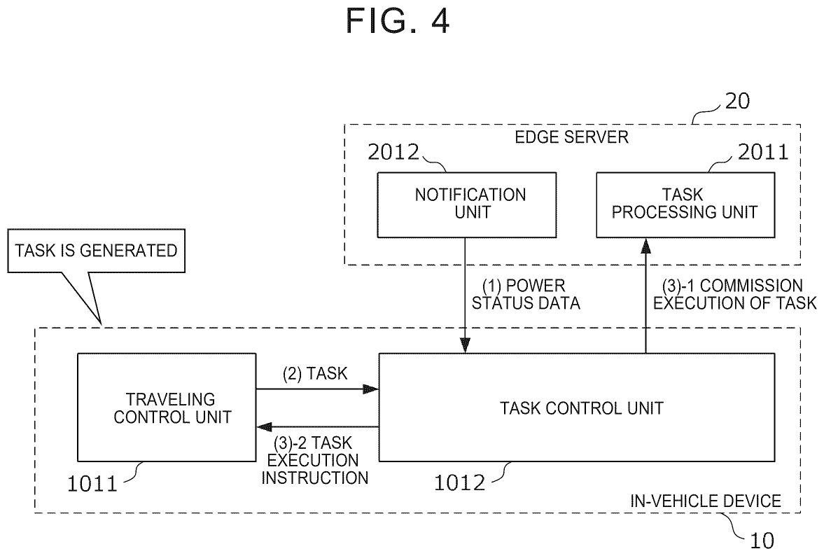

device 10 will be described. FIG. 4 is a diagram showing the flow of data when a task occurs in the in-vehicle device 10.

In this embodiment, the vehicle 1 is a vehicle that is capable of autonomous driving. As described above, the traveling control unit 1011 analyzes the sensor data that is acquired from the sensor group 11 to extract information that is necessary for autonomous driving, and controls the traveling of the vehicle 1 based on this information.

Now, the traveling control unit 1011 generates and executes tasks in real time while traveling, in order to analyze the road environment based on sensor data. Examples of tasks generated by the traveling control unit 1011 include a task to determine the position of lane marking lines, a task to detect other vehicles and determine types and positions thereof, a task to detect pedestrians or bicycles and determine positions thereof, and a task to determine aspects of traffic signal lights, and so forth. Also, another task is to decide the acceleration/deceleration and the path of the own vehicle based on the results of analysis thereof.

The task that is generated by the traveling control unit 1011 is, for example, a task for recognizing an object using a neural network. A neural network is made up of multiple layers, with nodes that are situated in each of the layers receiving multiple inputs and combining them to generate an output.
The task that is generated by the traveling control unit 1011 is passed to the task control unit 1012. An inference task using a neural network is executed for each of the layers, and accordingly the task that is generated by the traveling control unit 1011 is a task that can be divided into individual layers.

Next, operations of the task control unit 1012 will be described.

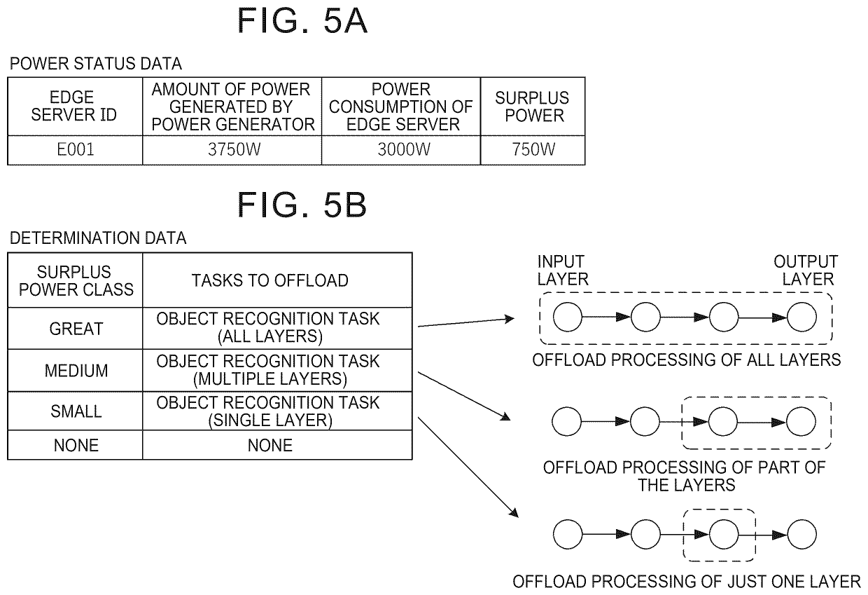

The task control unit 1012 receives the power status data from the notification unit 2012 of the edge server 20. FIG. 5A is an example of the power status data. As shown here, the power status data includes data regarding an identifier of an edge server (edge server ID), amount of power that is generated by the power generator 21 associated with the object edge server 20, the power consumption of the edge server 20, and surplus power. These data may be generated by the notification unit 2012 based on information that is obtained from the power receiving unit 204 of the edge server 20. For example, when the amount of power that is generated by a power generator exceeds the power consumption by an edge server, the difference thereof is surplus power. Conversely, when the amount of power that is generated by the power generator falls short of the power consumption of the edge server, the surplus power is 0 (none).
The task control unit 1012 may periodically receive power status data from the edge server 20.

Also, the task control unit 1012 acquires data regarding the power status of vehicle 1 (e.g., remaining charge of a traction battery) from an electric control unit (ECU) that the vehicle 1 is equipped with, and decides an entity that will execute the task, based on the power status of the vehicle 1 and the power status data that is received from the edge server 20. For example, when there is no surplus in power that is supplied from the vehicle 1 to execute a task (e.g., when the remaining charge of the traction battery is below a threshold value), commissioning the edge server 20 to execute this task may be preferable. On the other hand, even in such a case, commissioning for execution of the task may not be performable when the edge server 20 does not have surplus power.
Accordingly, the task control unit 1012 decides whether the task that is generated by the traveling control unit 1011 should be executed in the own vehicle or should be executed in the edge server 20, based on the power status of the vehicle 1 and the power status of the edge server 20.

The power status of the vehicle 1 and the power status of the edge server 20 can be classified as follows.
(1) When the own vehicle can supply enough power for the task
   When the vehicle 1 can supply sufficient power to execute the task, the task control unit 1012 decides that the object task is to be executed in the own vehicle. In this case, the task control unit 1012 issues an instruction to the traveling control unit 1011 to execute the object task.
(2) When the own vehicle cannot supply enough power for the task, and also the edge server has surplus power
   For example, when the power circumstances of the own vehicle are poor (e.g., the remaining charge of the traction battery is below a threshold value or the like) and the edge server 20 has surplus power, the task control unit 1012 decides to commission the edge server 20 to execute the object task. In this case, the task control unit 1012 transmits a commission to execute the object task, to the task processing unit 2011 of the edge server 20. When execution of the task is completed, the result thereof is returned from the edge server 20 to the task control unit 1012, and the task control unit 1012 performs transfer thereof to the traveling control unit 1011.
(3) When the own vehicle cannot supply enough power for the task, and also the edge server does not have surplus power
   For example, when the power circumstances of the own vehicle are poor (e.g., the remaining charge of the traction battery is below a threshold value or the like) and the edge server 20 has no surplus power, the task control unit 1012 decides to execute the object task in the own vehicle. In this case, the task control unit 1012 gives an instruction to the traveling control unit 1011 to execute the object task. Note that the task control unit 1012 may make a determination that the object task is unexecutable. In this case, the task control unit 1012 may return a response to the traveling control unit 1011 to the effect that the task cannot be executed due to poor power circumstances, and the traveling control unit 1011 may take an action such as stopping autonomous driving or the like, due to this.

Note that in the above-described case (2), the task control unit 1012 may adjust the amount of tasks regarding which execution is to be commissioned, depending on the amount of surplus power in the edge server 20.

For example, there are cases in which the traveling control unit 1011 generates multiple tasks at the same time, and in which the amount of tasks to be commissioned to be executed is not taken into consideration, execution of tasks of an amount that exceeds the surplus power may be commissioned.
Accordingly, the task control unit 1012 may acquire data (hereinafter, “determination data”) that defines a relation between the surplus power status and the tasks to be commissioned for execution, and decide the tasks to be commissioned for execution based on this data.

FIG. 5B is an example of the determination data. This data may be stored in the storage unit 102 in advance. In this example, the determination data is data that defines a relation between the classification of surplus power in the edge server 20 and the task regarding which execution is to be commissioned. In this example, for example, when the surplus power class is “great”, all layers of the object recognition task that is performed using a neural network are executed in the edge server 20. Also, when the surplus power class is “medium”, part (multiple) of the layers of this object recognition task are executed in the edge server 20. When the surplus power class is “small”, only a single layer of this object recognition task is executed in the edge server 20.

Note that an example is shown here in which the processing in the layers of the neural network is divided, but when there are multiple tasks that are generated by the traveling control unit 1011, the task control unit 1012 may decide which of the tasks to commission the edge server 20 to execute depending on the scale of each of the tasks (e.g., the amount of calculation required and so forth).

In this way, the task control unit 1012 may adjust the number of tasks regarding which execution is to be commissioned, or the amount of calculations, based on the surplus power status in the edge server 20. For example, the more surplus power there is, the more the task control unit 1012 can commission the edge server 20 to execute more tasks or tasks with a greater amount of calculation.

### Processing Flowchart

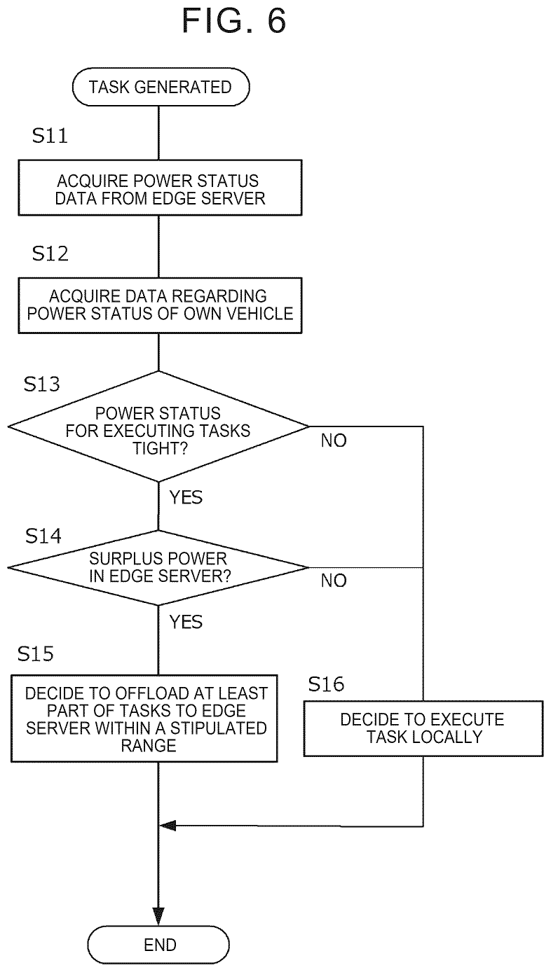

FIG. 6 is a flowchart of the processing that is executed by the in-vehicle device 10. This processing is executed when the traveling control unit 1011 generates a new task.
First, in step S11, the task control unit 1012 acquires the latest power status data from the edge server 20. Note that in a case in which the task control unit 1012 periodically acquires the power status data from the edge server 20, this step may be omitted.

Next, in step S12, the task control unit 1012 acquires data relating to the power status of the own vehicle. The data relating to the power status of the own vehicle is, for example, data indicating the remaining charge of the traction battery, or the like, but is not limited to this as long as whether a new task can be executed in the own vehicle can be determined. For example, in this step, data regarding the power currently being consumed by the own vehicle to execute tasks may be obtained. The data relating to the power status of the own vehicle may be acquired, for example, from an ECU or the like that manages the traction battery.

Next, in step S13, the task control unit 1012 determines whether the power status of the own vehicle for executing the task is tight. For example, when the remaining charge in the traction battery of the own vehicle is a predetermined value or lower, or when the power currently being consumed to execute a task is a predetermined value or higher, determination can be made that the power status for executing the task is tight.

When the determination in this step is positive, the processing transitions to step S14 to determine whether commissioning execution of the task to the edge server 20 is possible. When a negative determination is made in this step, the processing transitions to step S16.

In step S14, the task control unit 1012 determines whether this edge server 20 has surplus power, based on the power status data that is acquired from the edge server 20. The surplus power can be calculated based on, for example, the amount of power generated by the power generator 21 and the power consumption by the edge server 20, both of which are indicated by the power status data.

When the determination in S14 is positive, the processing transitions to step S15. When the determination in step S14 is negative, the processing transitions to step S16.

In step S15, the task control unit 1012 decides to commission the edge server 20 to execute at least part of the generated task, within a stipulated range.
Note that when commissioning the edge server 20 to execute the object task results in multiple tasks being executed simultaneously in the edge server 20, the task control unit 1012 may select the tasks to be commissioned for execution based on the number of object tasks and the amount of calculation. For example, the task control unit 1012 may decide the level of amount for the task to be commissioned the edge server 20 for execution, based on the status of the surplus power in the edge server 20, as described with reference to FIG. 5B.

As described above, the edge server 20 according to the first embodiment has a power generation facility that uses renewable energy, and has a function of notifying the in-vehicle device 10 regarding the power status of itself.
Also, when the status of power in the own vehicle is tight, the in-vehicle device 10 references the power status of the edge server 20 and commissions the edge server 20 to execute tasks to an extent possible.

According to this configuration, in a situation in which the edge server 20 is generating surplus power, this edge server can be made to perform processing of tasks that occur in the vehicle 1 as an alternative. In power generation facilities that use renewable energy, when power is generated that cannot be consumed, this power could not be utilized, but according to the present embodiment, the surplus power can be effectively utilized.

### Modifications

The above-described embodiments are merely examples, and the present disclosure may be appropriately modified and implemented without departing from the scope thereof.
For example, the processing and means described in the present disclosure can be freely combined and implemented as long as no technical contradiction occurs.

Also, in the embodiment, an example has been described in which the edge servers 20 have a predetermined communication area (e.g., a radius of several hundred meters) and communicate with vehicles 1 within that range, but the in-vehicle device 10 may also communicate with edge servers 20 in a remote location via a cellular network or the like. In this case, the in-vehicle device 10 may receive power status data from each of the edge servers 20 and determine whether a task can be commissioned to each of the edge servers 20.

Also, a form has been exemplified in the embodiment in which the power status data is in the form of FIG. 5A, but the form is not limited to this as long as whether there is surplus power in the edge server 20 can be determined.

Also, in the embodiment, the amount of tasks to be commissioned for execution, and so forth, is decided based on the surplus power in the edge server 20, but when there is still surplus power in the edge server 20 even after commissioning for execution all of the tasks, the in-vehicle device 10 may generate a new task.

For example, increasing the number of layers in a neural network may enable the accuracy of object recognition to be improved. For example, when the task control unit 1012 determines that there is still surplus power on the edge server 20 side even after commissioning the edge server 20 to execute all tasks that have been generated, the traveling control unit 1011 may be notified of this fact. In response to this notification, the traveling control unit 1011 may increase the number of layers of the neural network.

According to this configuration, for example, an effect of improved accuracy of autonomous driving can be obtained during periods when there is a surplus of power.
Note that the task control unit 1012 may instruct the traveling control unit 1011 to restore the increased number of layers of the neural network to the original level at a timing when there is no longer any surplus power on the edge server 20 side.

Also, processing, which has been described as being performed by one device, may be executed by a plurality of devices in cooperation. Alternatively, processing described as being performed by different devices may be executed by one device. In the computer system, the hardware configuration (server configuration) by which each function is realized can be flexibly changed.

Also, a task using a neural network is exemplified in the embodiment, but tasks that are generated in the vehicle 1 may be other than this. For example, when a plurality of microservices is being executed in the in-vehicle device 10, an entity that serves to execute the microservices as the execution entity thereof may be changed from the in-vehicle device 10 to the edge server 20 based on the surplus power of the edge server 20.

The present disclosure can also be realized by supplying a computer with a computer program that implements the functions that are described in the above embodiment, and causing one or more processors, which this computer is equipped with, to read and execute the program. Such a computer program may be provided to the computer by a non-transitory computer-readable storage medium that is connectable to a system bus of the computer, or may be provided to the computer via a network. Examples of the non-transitory computer-readable storage medium include a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), or the like, ROM, random access memory (RAM), erasable programmable read only memory (EPROM), electrically erasable programmable read only memory (EEPROM), a magnetic card, flash memory, an optical card, and any type of medium that is suitable for storing electronic commands.

What is claimed is:

1. An information processing device that is installed in a vehicle, the information processing device comprising
a control unit that executes
acquiring power status data that is data indicating a level of surplus power of an edge server, equipped with a power generation facility that uses renewable energy, and
commissioning the edge server to execute at least part of a plurality of calculation tasks generated in the vehicle, based on the power status data.

2. The information processing device according to claim 1, wherein the power status data includes data indicating power that is suppliable by the power generation facility and data indicating power consumption by the edge server.

3. The information processing device according to claim 2, wherein the control unit determines an amount of surplus power in the edge server based on the power status data, and commissions the edge server to execute the at least part of the calculation tasks when there is surplus power.

4. The information processing device according to claim 3, wherein, more surplus power that there is in the edge server, more calculation tasks the control unit commissions the edge server to execute.

5. An information processing system comprising:
one or more edge servers equipped with a power generation facility that uses renewable energy; and
an information processing device that is installed in a vehicle, wherein
each of the one or more edge servers transmits power status data that is data indicating a level of surplus power to the information processing device, and
when the power status data that is received from the one or more edge servers indicates that there is an edge server with surplus power, the information processing device commissions a corresponding edge server to execute at least part of a plurality of calculation tasks.
